(19) United States
(12) Patent Application Publication
(10) Pub. No.: US 2020/0085061 A1
(43) Pub. Date: Mar. 19, 2020

(54) HEAVY METAL-FREE CALCIUM HYDROXIDE-BASED ACTIVE SUBSTANCE

(71) Applicant: KALKFABRIK NETSTAL AG, Netstal (CH)

(72) Inventor: Wendelin Jan STARK, Langenthal (CH)

(21) Appl. No.: 16/469,699

(22) PCT Filed: Dec. 11, 2017
(86) PCT No.: PCT/EP2017/082176

§ 371 Date: Jun. 14, 2019

(30) Foreign Application Priority Data
Dec. 19, 2016 (EP) 16205018.1

(51) Int. Cl. A01N 59/06; A01N 25/02; A01N 37/06

(52) U.S. Cl. CPC A01N 59/06; A01N 37/06; A01N 25/02

(57) ABSTRACT

The invention relates to plant protection agents in the form of a liquid formulation containing a dispersion medium and a particulate composition that comprises a specific mixture of calcium hydroxide, fatty acids and, optionally, additives. The invention also relates to non-aqueous concentrates for providing such plant protection agents, and to the production of such particulate compositions.

The present invention relates to particulate composition suitable as a pesticide for spreading as a solid or liquid formulation, as well as its production.

Modern farming uses numerous products for increasing yield, securing and improving the quality of the crop, and has developed into a complex and challenging branch of science. The use of large amounts of artificial, generally synthetic chemical products has led to consequential problems in the environment, in particular with regard to biodiversity and ecosystem services, as well as in human health. These frequently grave consequences of using generally synthetic pesticides has led to a greater awareness of the problem by all participants so that today, many consumers and producers are switching or wish to switch to more sustainable methods.

The development of active substances with demonstrably less harm to the environment and humans is therefore fundamentally relevant. In addition to the environmental persistence of poorly degradable compounds and the associated possibility of enrichment in ecosystems and the food chain, the use of heavy metals is particularly problematic. A specific example of a problematic heavy metal is copper that on the one hand is highly successful against numerous harmful organisms but which can lead to significant pollution in the soil and water. Moreover, residual heavy metal enters the crop where it then for its part leads to exposure in humans.

Particularly in biological farming, there exists the tendency toward simpler products with a biodegradable active substance and limited duration of action. In this context, a series of active substances are known.

A) Copper salts and derivatives. Copper -containing products have been used for centuries in viticulture and are even permitted in biological farming with restrictions. The classic Bordeaux mixture, a dispersion consisting of a precipitated copper hydroxide derivative, is known. Under the trade name of Atempo fungus-free copper, pesticides are marketed that contain 100 g/L copper octanoate. In every case, however, the use of copper is undesirable since it leads to the aforementioned disadvantages.

B) Metal salts. Sedun (U.S. Pat. No. 5,395,851 and U.S. Pat. No. 5,246,716) describes formulations for treating tree wounds. The formulations contain metal salts of fatty acids; Ca, Cu, Fe, Mg and Zn are cited as metals. Whereas these formulations are suitable as a preventative measure in forestry, the spectrum of action in other fields is insufficient. In 1932, Schotte et al. (DE543308) described a powdered pesticide in which vegetable products such as tobacco dust or sawdust are superficially treated with metal salts in order to improve grindability. It was proposed to produce calcium sulfate or calcium oxalate in situ. The fungicidal or insecticidal effect originates from the vegetable product (tobacco) or from the added pesticide (formaldehyde) and not from the metal salt, however.

C) Coated calcium oxide. Stark (WO 2014/075197 and EP2944610) describes a modified calcium oxide and its use in plant protection, in particular as a fungicide or bactericide. The formulations described therein manifest a very good effect. However, the described materials are only suitable for dry formulations and not, however, for liquid formulations. The limitation to dry formulations is disadvantageous since dry methods of application are uncommon in agriculture. In particular the dust associated with such application methods, the spreading of dust clouds and the effort for occupational safety are disadvantageous.

There is therefore a need to transfer the spectrum of action of copper-containing formulations to a heavy-metal-free formulation, and to thus combine on the one hand effective plant protection and on the other hand favorable environmental compatibility. Such formulations should furthermore take into account economic and practical requirements, in particular easy applicability and economical production.

The above-outlined tasks are solved according to the independent claims. The dependent claims represent advantageous embodiments. Other configurations of the invention can be found in the description.

The invention will be explained in detail below. If no other meaning is indicated by the direct context, the following terms have the meaning indicated here.

The general, preferred and particularly preferred embodiments, fields, etc. provided in the context of the present invention can be combined with each other as desired. Likewise, individual definitions, embodiments, etc. may be omitted or irrelevant. The term “comprising” should include the meanings “containing” and “consisting of”. If not noted otherwise, percentages are indicated as percent by mass (percent by weight).

Particles or grain size. The term “particle size or grain size” is used synonymously, is generally known and can be determined using conventional methods. If not otherwise stated in the present invention, the particle size is indicated as the “average particle size”. For particles in the micrometer range (diameter greater than 10 micrometers), the measurement is preferably carried out using laser granulometry (such as Sympatec HELOS). For particles above 100 micrometers in size, sieve analysis is preferably used. An indication of 0-200 micrometers as the result of a sieve analysis means that the upper threshold for the particle size is 200 micrometers (for example by determining the sieve residue from elutriation), but the bottom threshold lies within a reasonable technical range (such as provided by a grinding method).

Stability: In the context of the present invention, the stability of a composition or formulation should be understood to mean that the composition is not subject to major changes under practical conditions, in particular usage as an active substance formulation in agriculture. Major changes can be chemical changes such as converting one chemical substance into another. Major changes can also be physical changes such as the baking of a powder, wherein this makes the substance useless. The latter are in particular of interest in dispersions since dispersions can on the one hand be good dispersions (from the perspective of the user, i.e., remain useful long enough), or on the other hand bad dispersions (that are difficult to use from the perspective of the user and therefore are uneven or no longer pumpable or sprayable, or even decompose and form a solid sediment and a clear supernatant at the top in the dispersion). Chemical changes can be demonstrated with corresponding analytical methods and are sufficiently known to a person skilled in the art. Physical changes are also measurable using suitable methods and are known to a person skilled in the art.

In a first feature, the invention therefore relates to a particulate composition containing a mixture of (a) calcium hydroxide, (b) fatty acids and possibly (c) additives.

It was revealed that these compositions have a surprisingly broad spectrum of action in the field of plant protection and are simultaneously stable enough so that a solid or liquid formulation can be created. Finally, these compositions are easy to produce and are economical due to their starting materials.

Upon coming into contact, the components (a) and (b) are reactive and form calcium salts of fatty acids while splitting off water. This reaction can occur partially or completely. If low amounts of (b) are added, this component may react completely so that the composition contains the calcium salt of the fatty acid in addition to calcium hydroxide, but no free fatty acid. When there are higher shares of fatty acid, conversion may be incomplete, and the composition therefore contains calcium hydroxide, the calcium salt of the fatty acid, and free fatty acid. The particulate compositions described here therefore contain components (a) and (b) and/or their reaction products (i.e., especially calcium salts of fatty acids), as well as perhaps component (c) and perhaps water. The mixture of components (a) and (b) as well as the reaction products is also termed “active substance” in plant protection due to their effect (see the third feature of the invention and examples).

This first feature of the invention will be explained further below, in particular with reference to the individual components.

Component (a), calcium hydroxide, also termed slaked lime or hydrated lime. The term is known and basically describes calcium hydroxide Ca(OH)₂ with an alternating amount of moisture, residual carbon dioxide and possibly residual calcium oxide. The amount of organic material as an impurity is very low (less than 1 g per kg calcium hydroxide) since the material is produced by dissolving (reacting with water) burnt lime. The latter is produced by calcining (heating to at least 700°, generally above 1000° C.) limestone; in so doing, organic compounds burn up. Typical materials contain >90 wt. % Ca(OH)₂. The material typically exists as a very fine powder with a particle size within the range of micrometers. Calcium hydroxide is resistant to moisture in air, but slowly absorbs carbon dioxide (carbonation) from the air. Due to the low CO₂ concentration in the air, carbonation is very slow, and calcium hydroxide is therefore considered stable under ambient conditions for most uses in air.

Heavy metal content: The compositions of the present invention are free of heavy metals and are hence environmentally friendly. Metals are termed a heavy metal having a density above 5 g/cm³. Correspondingly, component (a) has a heavy metal content of less than 5000 ppm, preferably less than 1,000 ppm, in particular less than 500 ppm, for example less than 100 ppm. For certain heavy metals such as copper, cadmium, mercury or lead, additional thresholds may apply in the field of plant protection; these can be easily maintained by the compositions described herein. The heavy metal content of the individual components, the composition and the formulation can be measured using various methods depending on the element and is sufficiently known to a person skilled in the art. For example, ICP-MS (inductively coupled plasma mass spectroscopy) or AAS (atom absorption spectroscopy) that determine these values in comparison with a reference are suitable.

Suitable qualities of component (a) are commercially available, for example from the company Kalkfabrik Netstal AG, under the name of nekapur 2 or nekablanc 0 (“white lime hydrate”, “dissolved lime”).

Component (b), fatty acids: The term “fatty acids” is known and comprises carboxylic acid so that all are termed shorter, medium length or longer fatty acids. C₁ to C₅ carboxylic acids (formic acid to valeric acid) are termed a short chain. C₆ to C₁₄ carboxylic acids are termed carboxylic acids of a medium chain length. Long-chain carboxylic acids contain at least 15 carbon atoms per acid unit. The substance class of “fatty acids with an average chain length” comprises the carboxylic acids hexanoic acid (C₆), octanoic acid (C₈), and decanoic acid (C₁₀), dodecanoic acid (C₁₂) and tetradecanoic acid (C₁₄). In addition the uneven Cₙ fatty acids, C₇, C₉, etc. also belong to this substance class that however are rare in fatty acids of a natural origin. Hexanoic acid (C₆), octanoic acid (C₈), decanoic acid (C₁₀), dodecanoic acid (C₁₂) and tetradecanoic acid (C₁₄) are preferred.

Fatty acids comprise saturated and unsaturated fatty acids, wherein saturated fatty acids are preferred. Most fatty acids have only one acid function per molecule. Most fatty acids are not further functionalized and linear. Rare fatty acids contain additional functional groups, in particular hydroxyl groups, or branches.

Fatty acids can exist as a chemically pure compound or as a mixture of different fatty acids. In the context of this invention, both pure fatty acids as well as fatty acid mixtures are comprised by the term “fatty acid”.

Depending on production, fatty acids with lesser chemical purity are used; accordingly fatty acids of a technical purity (technical grade”) are also comprised.

In one embodiment of the invention, component (b) is obtained from natural sources.

In one embodiment of the invention, at least 50 wt. % of component (b) is formed from fatty acids of an average chain length (C₆ to C₁₄). Preferably, 50 wt. % of component (b) is formed from fatty acids of the group consisting of octanoic acid, decanoic acid, and dodecanoic acid; particularly preferably, at least 50 wt. % of component (b) is formed from octanoic acid.

In another embodiment of the invention, at least 80 wt. % of the fatty acid molecule (b) has a chain length of at least six carbons (hexanoic acid).

In another embodiment of the invention, component (b) is a pure C₈₋₁₂ fatty acid.

In another embodiment of the invention, component (b) is a mixture of fatty acids, wherein at least 80 wt. % of the fatty acid molecule has a chain length of at least 8 carbon atoms (octanoic acid).

Fatty acids, component (b), are commercially available. Component (b) can be obtained from natural sources, for example by purifying and possibly distilling hydrolyzed fats, or from industrial production. The chain length of the fatty acids is variable and can change depending on the specific use, wherein C₆ to C₁₄ fatty acids, in particular C₈ to C₁₂ fatty acids, have a frequently preferred effect.

The term fatty acid ester is known and comprises esters of the aforementioned fatty acids. As ester components, short chain alcohols, i.e., C₁₋₄ alcohols, are preferred. Methanol is particularly suitable; correspondingly, the fatty acid methyl esters are especially suitable.

Accordingly, the substance class of “fatty acid esters with a medium-size chain length” comprises the esters of hexanoic acid (C₆), octanoic acid (C₈), decanoic acid (C₁₀), dodecanoic acid (C₁₂) and tetradecanoic acid (C₁₄), palmitic acid (C₁₆) and stearic acid (C₁₈); in particular, the respective methyl ester. Methyl esters of canola oil (C₆ to C₂₂) are preferred. In another embodiment of the invention, at least 80 wt. % of the fatty acid molecule (b) has a chain length of at least six carbons (hexanoic acid). Fatty acid esters comprise saturated and unsaturated fatty acids, wherein saturated fatty acid esters are preferred.

Natural fatty acid esters have one or more ester function per molecule; the esters are either not further functionalized, and are frequently linear. Other fatty acid esters contain additional functional groups, in particular hydroxyl groups, or branches.

Fatty acid esters can exist as a chemically pure compound or as a mixture of different fatty acids. In the context of this invention, both pure fatty acid esters as well as their mixtures are comprised by the term fatty acid ester. Fatty acid ester mixtures are frequently advantageous. These are used inter alia as biofuels or as raw materials in the production of consumer goods, cosmetics and food additives.

Depending on production, fatty acid esters with lesser chemical purity are used; accordingly fatty acids of a technical purity (“technical grade”) are also comprised. In the context of the present invention, special impurities with fatty acids are generally not problematic. Correspondingly, the term fatty acid ester also comprises those products that contain up to 5 wt. % fatty acids.

In one embodiment of the invention, at least 50 wt. % of component (b) is formed from fatty acids of chain length (C₆ to C₂₂). Preferably at least 50 wt. %, preferably at least 80 wt. %, of component (b) is canola acid methyl ester or another methyl ester of a widely used vegetable oil such as coconut oil, palm oil or sunflower oil.

In another embodiment of the invention, component (b) is a pure C₆₋₂₂ fatty acid methyl ester.

In another embodiment of the invention, component (b) is a mixture of fatty acid esters, wherein at least 80 wt. % of the fatty acid molecule has a chain length of at least 8 carbon atoms (octanoic acid).

Fatty acid esters, component (b), are commercially available, for example under the brand name of Agnique by BASF. Component (b) can be obtained from natural sources, for example by purifying and possibly distilling hydrolyzed fats, or from industrial production. The chain length of the fatty acids is variable and can change depending on the specific use, wherein C₆ to C₂₂ fatty acids, in particular C₈ to C₁₂ fatty acids, have a frequently preferred effect.

It has been proven that fatty acids or fatty acid esters as described here can be used as component (b) fatty acids or fatty acid esters. Likewise, mixtures of fatty acids and fatty acid esters are suitable as component (b). Both fatty acids as well as fatty acid esters lead to particulate compositions which are effective in use as pesticides. Without feeling bound by theory, it is assumed that fatty acid esters partially or completely saponify in the presence of calcium hydroxide Ca(OH)₂ in the production into the corresponding acids. The reaction products of the fatty acid esters and calcium hydroxide are accordingly deposited on the particles.

Component (c), additives: The compositions according to the invention can contain additives. Such additives are known to a person skilled in the art and contain dispersants, anti-caking agents, stabilizers, wetting agents, film performers, etc. The amount and type of the auxiliary agents depends on the desired uses as described below. Preferably, such additives are selected that do not act with component (a) or (b).

In one embodiment of the invention, the composition is free of additives; it therefore only consists of the components (a) and (b) as well as their reaction products as described above.

In an alternative embodiment of the invention, the composition contains additional additives; it therefore only consists of the components (a) and (b) as well as their reaction products, and component (c).

Particulate composition: The term is known and relates to a material composition consisting of a plurality of individual particles. The term relates to solids and accordingly comprises especially powders and granulates.

Advantageously, the powdered compositions have a particle size of 1 to 200, preferably less than 100 μm. Such powders are in particular suitable for dry applications.

The particles of granulates are generally larger, typically within a range of 20 μm to 10 μm, preferably larger than 100 μm. The granulate particles typically consist of a plurality of adhering individual particles. These individual particles on their part are within a range of 1 to 200 μm large. Typically, such granulates are mixed with a liquid before use.

The aforementioned particle sizes can be adjusted using known methods, for example by sifting, grinding and granulating. Particle sizes can be determined according to the aforementioned methods.

In the compositions according to the invention, the aforementioned components (a), (b) and possibly (c) can be varied within wide ranges. Since the molar masses of fatty acids differ strongly, an indication in percent by weight seems unsuitable; instead, the acid neutralization capacity and the basicity of the composition as described below is defined as a suitable parameter.

As mentioned above, components (a) and (b) react with each other to form calcium soaps (calcium salts of fatty acids) and water. The particulate compositions therefore contain calcium hydroxide particles that are partially or completely covered by calcium soaps, as well as perhaps particles of calcium soaps and perhaps particles of calcium hydroxide in varying ratios of quantity. The amount of free fatty acid (component (b)) is rather low. Advantageously, the particulate composition has at least 50 wt. % calcium hydroxide particles (preferably at least 80 wt. %, particularly preferably at least 90 wt. %) that are partially or completely covered by calcium soaps, as well as perhaps up to 30 wt. % particles of calcium soaps (preferably up to 15 wt. %, particularly preferably up to 8 wt. %), and possibly up to 20 wt. % particles of calcium hydroxide (preferably up to 5 wt. %, particularly preferably up to 2 wt. %).

Acid neutralization capacity. A suitable quantitative description is the ability of a certain mass of the composition according to the invention to provide a certain amount of base equivalents. The acid neutralization capacity is therefore indicated as the molality [b_{H+}], i.e., in moles of acid [n_{H+}] that are provided per kg composition [m_{zus}]. Suitable compositions have an acid neutralization capacity b_{H+} of at least 5 moles per kilogram, preferably of at least 6 mol/kg, particularly preferably 8 mol/kg. Preferred compositions have an acid neutralization capacity of b_{H+} 6 to 26 moles of acid per kg active substance.

The acid neutralization capacity of a composition can be determined from the molar mass and its chemical behavior; examples are indicated in the following table:

| | Component (a): | Component (b): | |
|---|---|---|---|
| # | Ca(OH)₂ | Ca salt | Molality b [mol/kg] |
| 1 | 33.3 wt. % | 66.6 wt. % calcium ocanoate | 13 |
| 2 | 10 wt. % | 90 wt. % calcium ocanoate | 8 |
| 3 | 50 wt. % | 50 wt. % calcium ocanoate | 16 |
| 4 * | 95 wt. % | 5 wt. % calcium stearate | 26 |
| 5* | 90 wt. % | 10 wt. % calcium ocanoate | 25 |
| 6* | 80 wt. % | 20 wt. % Ca salts of C₈, | 20 |
| | | C₁₀ and C₁₂ fatty acids | |

Composition #2 is particularly preferred. This manifests an outstanding effect in viticulture, but is more expensive than the calcium hydroxide-richer mixtures.

Composition #4 is particularly preferred. This is economical to produce and manifests an outstanding effect.

Composition #5 is particularly preferred. This is economical to produce and manifests an outstanding effect.

Composition #6 relates to a mixture of 20 wt. % calcium salts of the medium-length of fatty acids (C₈, C₁₀ and C₁₂ acids). Depending on the composition, the capacity varies but is at least 20 mol acid per kilogram of this mixture. Composition #6 is particularly preferred. This is economical to produce and manifests an outstanding effect. The fatty acid mixtures can originate from natural sources and, as a mixture, are frequently more economical than pure substances.

It is noted that compounds with very high acid neutralization capacities b_{H+} are known, such as for example NaOH (b_{H+}=25 mol/kg); Li2CO3 (b_{H+}=27 mol/kg), or NH₃, 59 mol/kg).

Such compounds are however either not weather-resistant (all of the above compounds are very water-soluble and are washed off by precipitation), volatile (ammonia), or expensive (lithium salts) and therefore are not of practical interest in plant protection.

pH: The pH of the inventive compositions lies within the alkaline range. In one advantageous embodiment, the composition has a pH greater than 11.0 (measured as 5 wt. % (aq) as described below); preferably above 11.5, particularly preferably above 12.0.

The pH of pesticides generally deviates only slightly from a neutral value and is normally pH 4 to 10. The reason for this is that damage to the plant is to be avoided. In the present invention, it was unexpectedly found that the inventive compositions do not cause any damage to plants even though they are much more alkaline, i.e., have a pH significantly above 10.

The inventive compositions can be used as dry dusts (see the third feature); then the pH can be measured by adding a specific amount of the composition to a specific amount of water, stirring until the pH is constant, and then the pH is measured. Since the inventive compositions are used as pesticides and these are typically employed as aqueous dispersions, the following method should be used in the context of this invention to determine the pH: 50 g of composition is provided, the overall volume is filled to 1 L, mixed for at least 15 minutes, and the pH is measured. There is further mixing for an additional 15 minutes, and the pH is remeasured. If the pH then deviates less than 0.1 pH units from the pH of the previous measurement, the last value can be used as the relevant pH. If the deviation is greater, stirring must continue for an additional 15 minutes, and the pH is remeasured. This is repeated until the pH of the last two measuring points deviates less than 0.1 pH units from each other.

The inventive compositions can be used in the form of a dispersion (see third feature). The pH of the dispersion is then measured. However, a filter must be placed in front of the pH electrode to prevent its contamination. Typical dispersions of the active substances used here contain 0.1 to 10 wt. % of the composition in water, i.e., 1 to 100 g/L dispersion. Less amounts of below 0.1 wt. % in water can be used, but are less attractive for practical reasons. Amounts greater than 100 g/L can also be used, but since they are increasingly difficult to handle, especially when spraying, they are less attractive for practical reasons.

In a second feature, the invention relates to a method for producing a composition as described here (in particular the first feature of the invention) comprising the steps (i) provide and combine the components (a) and (b), (ii) add the component (c) if applicable.

This second feature of the invention will be explained below.

Step (i): The provision and combination of solid particulate starting materials as well as liquid starting materials are known per se. The mechanical mixture of fatty acids with calcium hydroxide leads to the formation of mixtures of calcium fatty acid salts and calcium hydroxide. The composition of the mixture thus formed depends on the amount of the respective starting substances and their type (such as medium chain length of the fatty acids).

The starting substances can be mixed in commercially available mixers. Suitable equipment is known to the person skilled in the art and comprises inter alia ribbon mixers and high-energy mixers. Suitable equipment is found in numerous other industrial fields such as the food industry when processing powdered products.

The starting substances are added in one or more steps or sequentially to the mixing vessels depending on the size of production (quantity per production step) and the type of production (continuous production or batch production of the active substance), as well as the available equipment. Depending on the type and purpose of the specific composition, the dwell time in equipment and the optimum processing parameters (temperature, speed of rotation, type of mixing elements or machine components such as lump breakers).

Technical fatty acid salts of calcium are products with a typically broad composition range due to the poor solubility and the generally highly mechanical production based on mixing. For example, the company aic describes its product as follows in its datasheet for calcium caprylate monohydrate (calcium octanoate): Calcium content: 10.4-12.8%; caprylic acid content: 75.3-92.1%; the heavy metal content is itemized in detail. A person skilled in the art understands that such fatty acid salts arise during the above production of mixtures and therefore are included as such in the context of the present invention. Consequently, the present compositions as such are more describable functionally than exactly chemically. Correspondingly in the context of this invention, the composition of the materials used is always referenced, and this is indicated in percent by weight.

Step (i) is typically performed at temperatures that lie above the melting point of component (b).

Step (ii): The mixing of a particulate composition with additives is known per se and can be done in commercially available equipment.

In one advantageous embodiment, the invention relates to a method as described here, wherein first the components (a) and (b) are ground in a mill at temperatures of 20-80° C. in step (i), and then if applicable additives are sprayed as a liquid formulation in step (ii).

In a third feature, the invention relates to pesticides containing or consisting of the composition as described here (in particular the first feature of the invention).

This third feature of the invention will be explained below.

Type of application and formulation. The agents described here can be used as a solid or liquid formulation. Both forms of application, i.e., dry (typically as a dust) and wet (especially as a dispersion) have certain advantages and, depending on the treatment target (in particular plants or seeds as well), season, local conditions (in particular field size, distance from adjacent cultures and waterways of residential areas), one or the other form of application will be advantageous.

Liquid formulations: In general, a use as a dispersion is advantageous since these wet forms of application yield a more local use of the active substance. The currently used forms of application are instead based on large liquid drops which reduces transportation by wind (the drops fall faster in the air to the ground), and adhesion to the plants is better. Drops within a range of 10 μm to 1 mm in the wet application of the pesticide according to the invention are considered advantageous. Correspondingly, the compositions according to the invention can be added to a dispersion medium (d) (in particular water or aqueous solutions) and transformed into a liquid dispersion under agitation or other suitable dispersion equipment. These can be spread using known equipment onto the target to be treated (in particular plants). Suitable equipment is known and comprises commercially available hoses, spray arms, lances and atomizers. Typically, a supply tank is carried with an installed mixer on a corresponding means of transport (such as a tractor), and the dispersion is pumped by mean of pumps into the distribution arms where it is converted by nozzles into fine drops which then fall on the plants.

The invention therefore relates to a pesticide as described here in the form of a liquid formulation containing components (a), (b) and (c) at 0.1-10 wt. % (preferably 0.2-5 wt. %) and dispersion medium (d) at 90-99.9% (preferably 95-99.8 wt. %). A person skilled in the art is aware that such liquid formulations contain a concentration of active substances compatible with the corresponding target culture. Furthermore, the individual components of the liquid formulations are chosen so that an environmentally compatible product results. In one embodiment, said dispersion medium contains water, preferably 90 to 99.9 wt. %, oil, preferably 0.1to 9 wt. %; dispersant, preferably 0.1 to 5 wt. %; emulsifier, preferably 0.1 to 5 wt. %; and additives, preferably 0 to 8 wt. %.

Suitable oils (component d): are known to a person skilled in the art and comprise vegetable oils, glycerin esters of fatty acids, fatty acid esters such as described above, in particular methyl esters of canola oil or other vegetable oils.

Dispersants (component e) are surface-active substances (Grundl. Landtechnik, vol. 34 (1984) No. 2), or polymer compounds that can help distribute finely distributed but scarcely soluble or insoluble solids in a liquid and keep them suspended. Correspondingly, a person skilled in the art is aware of suitable dispersants. These comprise amphiphilic copolymers with a hydrophilic and a hydrophobic part, and other compounds that can preferably hold the solids in suspension sterically or by means of charges. Examples of dispersants are known under the brand names of TEGO Dispers Evonik) or Dispex (BASF) or Dispersogen (Clariant).

Suitable emulsifiers (component f) are known to a person skilled in the art and comprise Joncryl (BASF), Emuisogen (Clariant), BREAK-THRU EM and Intelimer (Evonik), Dimodan and Grindsted products (DuPont and Danisco), lecithins and monoesters of glycerin.

Suitable additives (component g) are known to a person skilled in the art and comprise a broad group of substances that are used in plant protection in order to improve one or more aspects of a pesticide. Examples of such aspects are the suitability for spraying the pesticide, preventing the separation of the dispersions used, or improved distribution of the pesticide on the leaf surface, or prevention of foaming when the user touches the pesticide. Suitable additives comprise aerosols (Solvay), Synergen (Clariant), thickeners, alginates, pectins, vegetable rubbers and resins, carob tree rubber, attapulgite, fuller's earth, starch, cellulose derivatives and others.

Concentrates: The above-described pesticides (liquid formulations) contain components (a) and (b) at comparatively low concentrations, typically 0.1-10 wt. %. These have the active substance concentration intended for the end-user such as the farmer. However, typically concentrates are traded as a commercial product in addition to pesticides; these have a significantly elevated concentration of active substance and are only ready to use after being diluted with water. The present invention therefore also relates to concentrates that for example are suitable for being converted by the end-user into a pesticide. In one embodiment, the invention therefore relates to a concentrate, in particular for producing a pesticide, containing non-aqueous dispersion medium at 66.7-87.5 wt. % and a particulate composition at 12.5-33.3 wt. %, wherein the particulate composition contains a mixture of (a) calcium hydroxide and/or calcium oxide; (b) fatty acids and/or fatty acid esters; and/or their reaction products; as well as the nonaqueous dispersion medium, liquid fatty acid esters, dispersant and emulsifier.

As explained, component (a) can contain both CaO as well as Ca(OH)₂. Since the dispersion the medium is nonaqueous, CaO is also stable. After producing the aforementioned pesticide by diluting with water, CaO is converted into Ca(OH)₂. The liquid fatty acid esters, dispersant and emulsifier are as described above. These concentrates manifest a very favorable storage stability which is unanticipated, especially in light of the high amount of component (a). Furthermore, they can be easily converted into the aforementioned liquid pesticide formulations by being diluted.

Solid formulations: Dry applications can be advantageous when the target is not to remain wet or is already dry. In this case, the treatment of seeds should be mentioned that are advantageously treated dry. In one embodiment, the agent described here is therefore spread as a solid, in particular as a dust. Suitable equipment is known for doing this and is used today in agriculture in order, for example, to spread rock flour. The invention therefore relates to a pesticide as described here in the form of a solid formulation, in particular in the form of a powder, consisting of (a) calcium hydroxide and (b) fatty acids.

In the treatment of plants, the liquid or solid formulations described here can be spread on the dry leaves of the plants or on the wet leaves of the plants.

Stability. Since the application on the field requires a certain robustness of the compositions, they must be stable for at least a few hours. Typical field applications include pre-mixing the delivered form or concentrate by means of suitable tools (stirrers, pumps) in a container that is subsequently brought onto the field to be treated by means of the vehicle. Correspondingly, the application process and transportation take a few hours; during this time, the pesticide must remain stable. Pesticides with a stability of less than one hour are therefore unsuitable for practical reasons. The pesticides according to the invention satisfy the criterion of stability. Correspondingly, the invention relates to pesticides as described here from the group of bactericides, fungicides and insecticides (effective against insects, mites and/or arachnids).

Mode of action. The action of the pesticide according to the invention is not known in detail, but it is surprising in light of the fact that a comparable effect can be achieved as with copper preparations. Without feeling bound by theory, the two following effects are considered important:
Placement of medium-length and a long fatty acids on plant surfaces even during phases of weather. In this case, the active substance is probably linked to the effect of soaps but improves the possible usage and the effective duration since the anions (carboxylic acid radicals of soaps) are available on the plant surface for days to weeks.
Provide acid neutralization options. Many microorganisms use organic acids in order to penetrate the protective mechanisms of the plant surface or in order to colonize the plant cells. One prominent acid in this context is oxalic acid. It is therefore suspected that the compositions according to the invention have a significant potential for neutralizing such acids given their calcium content. It is known that carboxylic acids frequently form scarcely soluble salts with calcium; in the case of oxalic acid, this is a specially insoluble calcium oxalic.

In another embodiment, the invention relates to the use of an agent as described here in viticultures, and/or in fruit cultures, and/or in vegetable cultures, and/or in greenhouse cultures. It was founded that specific mixtures are highly effective against various plant pests and are therefore attractive for use in plant protection. In particular, comparative tests with copper-containing, commercially available products have shown that the agents according to the invention have a comparable or even better effect than the copper preparations, but also have the advantage of being heavy-metal-free and therefore less polluting. Preferred compositions are mentioned under the first feature of the invention, and effect data are presented in the examples. Experimentally, compositions of calcium hydroxide and octanoic acid were recognized as being very efficient. Depending on the treatment target, longer carboxylic acids are advantageous. Due to the numerous treatment targets and types of application, suitable compositions and agents can be identified by a person skilled in the art in the context of simple test series and on the basis of the parameters described herein.

Profitability. Providing an effect on a culture (plants) generates costs. Generally, the overall costs consist of: Overall cost=(cost of pesticides and tools)+(cost per delivery). The cost per delivery consists of machine costs, personnel expenses, leases, etc. Some of these costs always exist per delivery (providing tools, machines, etc.), and they are independent of the material costs.

A treatment is therefore attractive when it (a) has low costs for the active substances and tools, and (b) must be done rarely. That is, the period between two applications of the active substance should be as long as possible. The pesticides according to the invention are economically attractive with regard to the addressed points (a) and (b).

Point (a): The agents according to the invention use mixtures of calcium hydroxide and calcium fatty acid salts. That is, part of the mass of the active substance can be made from an economical component (calcium hydroxide), and the end price of the active substance is therefore lower than is the case with formulations that are very rich in fatty acids.

A person skilled in the art will immediately recognize that an opportunity exists here for optimization, i.e., the question as to which increase in effectiveness per unit or weight tolerates which increase in cost.

For the pesticides described herein, the calcium hydroxide is about 10 times cheaper (per weight) than the fatty acids.

Since the molar weight of the fatty acids increases significantly with the chain length, shorter chain lengths lead to lower portions of fatty acids in the product, i.e., a comparable calcium salt is cheaper if it can be constructed from shorter fatty acids.

Point (b): The improved durability of calcium salts in comparison to the highly water-soluble traditional soft soaps (or also the Na salt or the NH₄ salt of the fatty acids) and weather (perhaps including rain but also dew) extends the duration of action and reduces the number of applications of the active substance during the growth of the crops/plants.

Duration of action/application frequency: The water solubility of the short chain fatty acid calcium salt is high, calcium acetate (fatty acid C₂) is highly water-soluble; calcium butyrate (fatty acid C₄) is still very water-soluble, whereas the medium fatty acids are scarcely soluble or practically insoluble.

It is thus revealed that the share of the two components (a) and (b) is flexible and may be different for various areas of application. This means in particular that different shares and different components (calcium hydroxide or the type and composition of the fatty acids) may be advantageous depending on the type of use (season, form of spreading), type of spreading (liquid or as a solid), type of plant (vine, onion, cherry, etc.) and pest (fungi, bacterial infections, insects).

The acid neutralization capacity is an important factor, but the distribution of the chain lengths of the fatty acid may be of interest to a person skilled in the art depending on the culture, conditions and the type of pest. Medium-length fatty acids are advantageous when treating mildew (in particular in viticulture), longer fatty acids are advantageous when treating brown rot (especially for tomatoes). When cultivating onions, the use of long-chain fatty acids in a low portion by weight (such as 5 or 10 wt. % with calcium hydroxide) may represent an economically attractive mixture.

In general, it is desirable to use it frequently for cultures that must be protected intensively (such as onions), and then to ensure an economical product (price per weight composition). This accordingly means a reduced amount of fatty acid salts in the inventive mixture. In applications at times of less precipitation (such as viticulture in the summer or early fall), it may be of interest to apply the active substance less frequently and to instead use higher portions of fatty acid salts in the active substance. In this case, for example active substances with 50, 66 or even more than 80 wt. % fatty acid salt are suitable. These compositions are then more expensive; their attractiveness is based on a longer interval of time between the applications and hence lower costs for spreading the active substance.

The examples cited below serve to further explain the invention; they in no way should restrict to the invention.

I. Solid Formulations

Productions of the Samples and Composition:

Different amounts of calcium hydroxide were mixed with different fatty acids (carboxylic acids). In all of the tests, a Fritsch Pulverisette 6 planetary mill was used with a grinder bowl of zirconium (volume=0.5 L; diameter: 10 cm, height: 7 cm) ata speed of 500 RPM.

### EXAMPLE 1

### Ca(OH)₂/5 wt. % Ca(St)₂

Calcium hydroxide was mixed with stearic acid in a planetary mill in batches of 100 to 200 g and by means of zirconium oxide grinding balls and heated while processing to at least 60° C. The composition of the material was 95 wt. % calcium hydroxide and 5 wt. % calcium stearate Ca(St)₂ that formed during the process by reacting calcium hydroxide and the employed stearic acid. The material is a very fine white powder.

### EXAMPLE 2

### Pure Ca(OH)₂ (Control Test Without Fatty Acid)

Calcium hydroxide was ground without additional additives by a planetary mill while using the same equipment and same duration of grinding.

### EXAMPLE 3

### CaCO₃/5 wt. % Ca(St)₂ (Control Test with Calcium Carbonate Instead of Calcium Hydroxide)

Calcium carbonate (limestone) was mixed with stearic acid in a planetary mill in batches of 200 to 300 g and by means of zirconium oxide grinding balls and heated while processing to at least 60° C. The nominal composition of the material was 95 wt. % calcium carbonate and 5 wt. % calcium stearate that provisionally formed during the process by reacting calcium carbonate and the employed stearic acid. The material is a very fine grayish white powder.

### EXAMPLE 4

### Pure Ca(St)2 (Control Test with Fatty Acid)

Calcium stearate was ground without additional additives by a planetary mill while using the same equipment and same duration of grinding.

The composition of the powder was confirmed by means of microanalysis (amount of C, H, N; Cube, Elementar, Germany). All of the above samples were forwarded together to a research institute and tested as the active substance:

Tests Against Plasmopara viticola on Grapes

The above-describe samples were tested in an independent plant research institute. The tests were set up as blind tests parallel to the following controls presented below.

Study Design:

Chasselas grapes (stage: 3-5 leaves; height 11-15 cm) were placed in pots (275 mL dirt per pot) as the target plants. During the test, the following conditions were maintained: humidity: 100% relative humidity; temperature of 20-21° C.; 16 of hours light per day. For inoculation, the abaxial side of the fully developed leaves of Plasmopara viticola (50,000 spores/mL) were sprayed, and the entire plant was inoculated.

Two types of all of the tests were performed: Type 1. Dust application on the dry test plant before inoculation with the pathogen (so-called standard method)

Type 2. Dust application on a wet test plant before inoculation with the pathogen.

Evaluation: according to (1) number of leaves with disease symptoms (disease incidence) (2) severity of the disease symptoms (disease severity): Portion of infected leaf surface in percent of the overall leaf surface. The combined “efficacy severity” was then calculated from this in percent.

Controls: (a) negative without treatment, (b) positive, treatment with a copper preparation, Kocide Opti 0.003%.

5 wt. % calcium stearate on calcium hydroxide (example 1) and pure calcium hydroxide (example 2) were checked in a study. 5 wt. % calcium stearate on calcium hydroxide manifested a better effect than the positive control. Pure Ca(OH)₂ however manifested only a slight reduction of the infection.

Results:

The results are compiled in the following tables; the results are depicted as an average±standard deviation.

| | % leaf surface with | | | | | |
|---|---|---|---|---|---|---|
| | symptoms of | | % infected | | Efficacy | |
| | infection | | leaves | | severity/% | |
| | Type of application: | | | | | |
| | Type 1 | Type 2 | Type 1 | Type 2 | Type 1 | Type 2 |
| | (dry) | (wet) | (dry) | (wet) | (dry) | (wet) |
| Example 1: | 16 +/− 9 | 8 +/− 7 | 65 +/− 15 | 40 +/− 18 | 83.2 | 91.8 |
| Ca(OH)₂/ | | | | | | |
| 5 wt. % Ca(St)₂ | | | | | | |
| Example 2: | 50 +/− 22 | 59 +/− 22 | 89 +/− 17 | 93 +/− 10 | 46.8 | 36.4 |
| Ca(OH)₂ 100 wt. % | | | | | | |
| Negative control | 93 +/− 4 | 93 +/− 4 | 100 | 100 | | |
| Positive control | 17 +/− 6 | 17 +/− 6 | 84 +/− 8 | 84 +/− 8 | 81.7 | 81.7 |

5 wt. % Calcium stearate on calcium carbonate (example 3) and pure calcium stearate (example 4) were checked in a study. Both are inactive and do not yield any relevant reduction of the infection.

| | % leaf surface with | | | | | |
|---|---|---|---|---|---|---|
| | symptoms of | | % infected | | Efficacy | |
| | infection | | leaves | | severity/% | |
| | Type of application: | | | | | |
| | | Type 2 | Type 1 | Type 2 | Type 1 | Type 2 |
| | Type 1 (dry) | (wet) | (wet) | (wet) | (dry) | (wet) |
| Example 3 | 42 +/− 7 | 47 +/− 9 | 91 +/− 10 | 86 +/− 11 | 37.6 | 30.3 |
| CaCO₃/ | | | | | | |
| 5 wt. % Ca(St)₂ | | | | | | |
| Example 4 | 62 +/− 20 | 58 +/− 8 | 93 +/− 10 | 91 +/− 10 | 7.3 | 13.3 |
| Ca(St)₂ 100 wt. % | | | | | | |
| Negative control | 67 +/− 18 | 67 +/− 18 | 92 +/− 20 | 92 +/− 20 | | |
| Positive control | 6 +/− 3 | 6 +/− 3 | 61 +/− 16 | 61 +/− 16 | 90.6 | 90.6 |

The results show that the pesticides according to the invention have an effect comparable with that of the positive control and are however free of heavy metals.

Moreover, it was revealed that the absence of one of the components (a) or (b) yielded ineffective products. Likewise, replacing Ca(OH)₂ with CaCO₃ yielded ineffective products.

II. Liquid Gormulations.

Production of a Concentrate

### EXAMPLE 5

To produce a liquid formulation, the following components were mixed with a Silverson mixer (agitator with large holes) at 4,000 RPM over 20 minutes (all entries in percent by weight):

| | |
|---|---|
| Agnique ME 18 RDF (fatty acid ester) | 53.8 |
| Ganex V220 (dispersant) | 4.0 |
| Attagel 50 (structuring agent) | 2.0 |
| AOT (emulsifier) | 4.5 |
| Soprophor BSU (emulsifier) | 4.5 |
| Brij L 4 (emulsifier) | 6.0 |
| nekagard 2 (Ca(OH)₂) | 25.2 |

The mixture was then mixed further with an Eiger ball mill (300 glass spheres with a diameter of 1.0 to 1.3 mm; 4,000 RPM, fill level 80%; 17 minutes). This yielded a gray, freely flowing liquid and a particle size D(50) of 2.2 μm and D(90) of 10.4 μm; measured with a Malvern Mastersizer 2000; before measuring, the samples were diluted with Agnique ME 18 RDF to thereby obtain a concentrate.

### EXAMPLE 6

To produce a liquid formulation, the following components were mixed with a Silverson mixer (agitator with large holes) at 4,000 RPM over 20 minutes (all entries in percent by weight):

| | |
|---|---|
| Agnique ME 18 RDF (fatty acid ester) | 53.8 |
| Ganex V220 (dispersant) | 4.0 |
| Attagel 50 (structuring agent) | 2.0 |
| AOT (emulsifier) | 4.5 |
| Soprophor BSU (emulsifier) | 6.0 |
| Brij L 4 (emulsifier) | 4.5 |
| nekafin 2 (CaO) | 25.2 |

The mixture was then mixed further with an Eiger ball mill (300 glass spheres with a diameter of 1.0 to 1.3 mm; 4,000 RPMs, fill level 80%; 17 minutes). This yielded a light gray, freely flowing liquid with a density of 1.17 g/cm³ (CIPTAC MT 3) and a particle size D(50) of 1.4 μm and D(90) of 3.7 μm; measured with a Malvern Mastersizer 2000; before measuring, the samples were diluted with Agnique ME 18 RDF to thereby obtain a concentrate.

Production of a Pesticide

Field Tests

The concentrates from examples 5 and 6 were tested in an independent plant research institute.

Study design: Before being spread, the above concentrates were diluted with water while stirring and tested on grapes as the plants at a dose of 0.5 wt. % to fight downy mildew.

Results: Pesticides produced by diluting the concentrate from examples 5 and 6 were highly effective against downy mildew when applied on grapes. The tested pesticides manifested a comparable or better effect than the reference treatments based on copper.

1. A pesticide in the form of a liquid formulation comprising:
dispersion media at 90-99.9 wt. % and a particulate composition at 0.1-10 wt. %;
wherein the particulate composition comprises a mixture consisting of:
calcium hydroxide (a), fatty acids and/or fatty esters (b) and/or their reaction products, and
optional additives (c); and
wherein
said calcium hydroxide (a) has a heavy metal content of less than 5,000 ppm;
at least 80 wt. % of said fatty acids and/or fatty acid esters (b) has a chain length of at least 6 carbon atoms;
said particulate composition has a pH of more than 11.0 (measured as 5 wt. % (aq)); and
said particulate composition has a neutralization capacity for acids b_{H+} of at least 5 mol/kg.

2. The pesticide according to claim 1, wherein the particulate composition contains:
at least 50 wt. % calcium hydroxide particles that are partially or completely covered by calcium soaps, wherein said calcium soaps are a reaction product of (a) and (b).

3. The pesticide according to claim 1, wherein
the calcium hydroxide has a heavy metal content of less than 1,000 ppm.

4. The pesticide according to claim 1 in which said particulate composition has:
a neutralization capacity for acids b_{H+} of 6 to 26 mol/kg, and/or
a primary particle size of 1 to 200 μm, and/or
a pH>11.5 (measured as 5 wt. % (aq)).

5. The pesticide according to claim 1, wherein the component (b) is obtained from natural sources, and/or at least 50 wt. % of the fatty acids are of a medium chain length selected from the group of C₆₋₁₄ carboxylic acids.

6. The pesticide according to claim 1, wherein said dispersion medium comprises:
water,
oil, in particular natural oils and fatty acid esters (d),
dispersant (e),
emulsifier (f), and
optionally additive (g).

7. A concentrate for producing a pesticide comprising non-aqueous dispersion medium at 66.7-87.5 wt. %, and a particulate composition at 12.5-33.3 wt. %, wherein the particulate composition contains a mixture of (a) calcium hydroxide and/or calcium oxide; (b) fatty acids and/or fatty acid esters; and/or their reaction products, and wherein the nonaqueous dispersion medium contains liquid fatty acid esters, dispersants and emulsifiers.

8. A method for producing a particulate composition that comprises a mixture of (a) calcium hydroxide; (b) fatty acids and/or fatty acid esters; and optionally (c) additives,
wherein said composition containscomprises:
calcium hydroxide particles that are partially or completely covered by calcium soaps, and
optionally particles of calcium soaps, and
optionally particles of calcium hydroxide,
has a pH of more than 11.0 (measured as 5 wt. % (aq)),
a neutralization capacity for acids b_{H+} of at least 5 mol/kg,
wherein said calcium hydroxide (a)
has a heavy metal content of less than 5,000 ppm,
wherein at least 80 wt. % of said fatty acids and/or fatty acid esters (b) has
a fatty acid chain length of at least 6 carbon atoms;
wherein said method comprises the steps:
i. providing and combining the components (a) and (b)
ii. optionally adding the component (c).

9. The method according to claim 8, wherein first the components (a) and (b) are ground in a mill at temperatures of 20-80° C. in step (i), and then if added, additives are sprayed as a liquid formulation in step (ii).

10. The pesticide according to claim 1 selected from the group of bactericides, fungicides and insecticides.

11. The use of an agent according to claim 1,
a. in viticultures; and/or
b. in fruit cultures; and/or
c. in vegetable cultures; and/or
d. in hothouse cultures.

12. The pesticide according to claim 2, wherein the particulate composition comprises up to 30 wt. % particles of calcium soaps, and up to 20 wt. % particles of calcium hydroxide.

13. The pesticide accordiing to claim 1, wherein the fatty acid is either
a pure fatty acid selected from the group of C₈₋₁₂ fatty acids, or
a mixture of fatty acids in which at least 80 wt. % of the fatty acid molecule contains a chain length of at least eight carbon atoms.

14. The pesticide according to claim 1, wherein the fatty acid ester is either
a pure fatty acid ester of a fatty acid with at least 6 carbon atoms and an alcohol with 1 to 4 carbon atoms, or
a mixture of fatty acid esters of fatty acids with at least 6 carbon atoms and one or more alcohols with 1 to 4 carbon atoms, and/or
a fatty acid ester obtained from the transesterification of natural plant oils with alcohol of 1 to 4 carbon atoms.

15. The pesticide according to claim 1, wherein at least one additive is present, the at least one additive being selected from the group consisting of dispersants, anti-lumping agents, stabilizers, wetting agents and film formers.

16. The pesticide according to claim 6, wherein said dispersion medium comprises:
90-99.9 wt. % water,
0.1-9 wt. % natural oils and fatty acid esters (d),
0.1-5 wt. % dispersant (e),
0.1-5 wt. % emulsifier (f), and
8 wt. % additive (g).
